(19) United States
(12) Patent Application Publication
(10) Pub. No.: US 2022/0166247 A1
(43) Pub. Date: May 26, 2022

(54) SMART HOME SYSTEM

(71) Applicant: MLS CO., LTD, Zhongshan (CN)

(72) Inventors: Chiulin Yao, Zhongshan (CN); Wuqiang Liao, Zhongshan (CN)

(21) Appl. No.: 17/534,379

(22) Filed: Nov. 23, 2021

Related U.S. Application Data
(60) Provisional application No. 63/116,935, filed on Nov. 23, 2020.

(51) Int. Cl. H02J 7/04; H04L 12/28; H04W 76/14; H05B 47/19; H02J 7/00

(52) U.S. Cl. CPC H02J 7/04; H04L 12/283; H04W 76/14; H04W 84/18; H02J 7/00032; H02J 7/0047; H04L 2012/2841; H05B 47/19

(57) ABSTRACT

Disclosed is a smart home system, including N wireless smart products and a fast-charging control circuit used as an accessory, where the fast-charging control circuit includes a charging control module, a charging conversion module and a charging detection module, and the charging conversion module is connected to a power supply and the wireless smart products; the charging control module receives and processes detected data output by the charging detection module to obtain a data processing result, and sends a regulation instruction to regulate a real-time charging status; and each of the N wireless smart products is communicatively connected to a Wi-Fi router, or the N wireless smart products are communicatively connected to each other through Bluetooth signals, each of M wireless smart products is equipped with a Bluetooth mesh gateway, and R wireless smart products each equipped with the Bluetooth mesh gateway are communicatively connected to the Wi-Fi router.

### CROSS REFERENCE TO RELATED APPLICATIONS

The present application claims the benefit of U.S. Provisional Patent Application No. 63/116,935 filed on Nov. 23, 2020, the contents of which are incorporated herein by reference in their entirety.

### TECHNICAL FIELD

The present disclosure relates to the technical field of smart home, and in particular, to a smart home system.

### BACKGROUND

With the booming national economy and the continuous scientific and technological improvement, there are increasingly high requirements for the home environment. Smart home aims to connect various smart devices in the home together by means of the Internet of Things (IoT) technology, to establish a system for efficiently managing residential facilities and household duties, making the home environment safer, more convenient, comfortable, and artistic. As of now, smart home is quite popular on the market.

As there are more types of wireless smart products, there are higher requirements for performance such as control, connection, adaptation, use, and battery life of the products. However, the current smart home system features relatively low network coordination capabilities, a single function, and unsatisfactory intelligent optimization. Therefore, to improve experience of users for the smart home system, it is very beneficial to design a smart home system with better performance.

### SUMMARY

The present disclosure provides a smart home system, which can effectively overcome the drawbacks in the prior art, and promote the intelligentization process of the home system.

To resolve the foregoing technical problems, an embodiment of the present disclosure provides a smart home system, including:

N wireless smart products and a fast-charging control circuit adapted to the wireless smart products, where N≥3, and the fast-charging control circuit includes a charging control module, and a charging conversion module and a charging detection module that are controlled by the charging control module, an input terminal of the charging conversion module is connected to a power supply, and an output terminal of the charging conversion module is connected to charging input terminals of the wireless smart products; the charging control module is at least configured to:

receive and process detected data output by the charging detection module to obtain a data processing result, and send, to the charging conversion module, a regulation instruction corresponding to the data processing result, so as to regulate a real-time charging status of the fast-charging control circuit for the wireless smart products; and

each of the N wireless smart products is communicatively connected to a wireless fidelity (Wi-Fi) router, or

the N wireless smart products are communicatively connected to each other through Bluetooth signals, and each of M wireless smart products is equipped with a Bluetooth mesh gateway, where N≥M≥1, and R wireless smart products each equipped with the Bluetooth mesh gateway are communicatively connected to the Wi-Fi router, where M≥R≥1.

In one of the embodiments of the present disclosure, the charging conversion module may include a rectifier bridge and an AC-DC conversion circuit, an input terminal of the rectifier bridge may be connected to the power supply, an output terminal of the rectifier bridge may be connected to an input terminal of the AC-DC conversion circuit, and an output terminal of the AC-DC conversion circuit may be connected to the charging input terminals of the wireless smart products;

the charging control module may include a processor and an AC-DC conversion control circuit, a control terminal of the AC-DC conversion circuit may be connected to the AC-DC conversion control circuit, and the AC-DC conversion control circuit may be connected to the processor; and

the charging detection module may be a charging output detection circuit, a detection terminal of the charging output detection circuit may be connected to the output terminal of the AC-DC conversion circuit, and an output terminal of the charging output detection circuit may be connected to the processor.

In one of the embodiments of the present disclosure, the processor may be configured to:

obtain, by using the charging output detection circuit, state parameters of the charging conversion module for supplying power to the wireless smart product, where the state parameters may include a charging circuit, a charging voltage, and a battery charging state; and

process the state parameters to obtain a data processing result, and send, to the AC-DC conversion control circuit, a regulation instruction corresponding to the data processing result, so that the AC-DC conversion control circuit may control the AC-DC conversion circuit to achieve regulation of charging start and stop, a charging voltage, and a charging time.

In one of the embodiments of the present disclosure, the smart home system may further include a smart terminal device, and the processor may be configured to:

receive a regulation instruction sent by the smart terminal device, and regulate a real-time charging status of the charging conversion module for the wireless smart product in response to the regulation instruction; and

obtain, by using the charging output detection circuit, state parameters of the charging conversion module for supplying power to the wireless smart product, and report the state parameters to the smart terminal device, where

the smart terminal device may be communicatively connected to a wireless communication module in the processor through a protocol conversion device such as a gateway.

In one of the embodiments of the present disclosure, when M=1, one of the N wireless smart products is equipped with the Bluetooth mesh gateway, and in this case, the N wireless smart products may be communicatively connected to each other through Bluetooth signals, to form a wireless mesh network.

In one of the embodiments of the present disclosure, when N≥M>1, at least one of the M wireless smart products each equipped with the Bluetooth mesh gateway may be selected, based on an election algorithm, from the N wireless smart products to be enabled with a Wi-Fi function and communicatively connected to the Wi-Fi router; and the N wireless smart products are communicatively connected to each other through Bluetooth signals, to form a wireless mesh network.

In one of the embodiments of the present disclosure, when N≥M>1, one of the M wireless smart products each equipped with the Bluetooth mesh gateway may be selected, based on an election algorithm, from the N wireless smart products to be enabled with a Wi-Fi function and communicatively connected to the Wi-Fi router; and the N wireless smart products are communicatively connected to each other through Bluetooth signals, to form a wireless mesh network.

When one wireless smart product, with the Wi-Fi function enabled, of the wireless smart products each equipped with the Bluetooth mesh gateway is powered off during work, another wireless smart product of M-1 wireless smart products each equipped with the Bluetooth mesh gateway may be selected based on the election algorithm to be enabled with the Wi-Fi function and communicatively connected to the Wi-Fi router.

In one of the embodiments of the present disclosure, a manner of electing a mesh gateway from M wireless smart products each equipped with the Bluetooth mesh gateway may specifically be:

establishing a wireless mesh network by using M wireless smart products each equipped with the Bluetooth mesh gateway in a local area network, selecting, based on an election algorithm, one of the wireless smart products in the wireless mesh network as the mesh gateway to be enabled with the Wi-Fi function and communicatively connected to the Wi-Fi router; or

after establishing a wireless mesh network by using M wireless smart products each equipped with the Bluetooth mesh gateway, registering the M wireless smart products to a cloud via the Internet, selecting, by the cloud, one of the M wireless smart products as the mesh gateway to be enabled with the Wi-Fi function and communicatively connected to the Wi-Fi router; and

the smart home system may further include a smart mobile terminal, and a software interface of the smart mobile terminal may be provided with a function key of a gateway election manner for a user to select.

In one of the embodiments of the present disclosure, the wireless smart product equipped with the Bluetooth mesh gateway may be enabled with a Wi-Fi function to implement remote control, a cloud online function of a device, and a software function setting.

In one of the embodiments of the present disclosure, the wireless smart product may include a smart lamp.

Compared with the prior art, embodiments of the present disclosure have the following beneficial effects: The structure of the smart home system is optimized by improving the charging circuit, the network system framework, and the like of the smart home system, so that the charging rate of the smart home devices is greatly increased, the charging monitoring of the devices is more effective, and the network coordination capability between the devices is greatly improved. The interconnection between the devices is no longer limited by the quantity of activations, the entire smart home system has a high degree of automation, and the use performance is greatly improved, thereby lowering a use threshold for the user, simplifying an operation of the user, and promoting an intelligentization process of the entire smart home system.

### BRIEF DESCRIPTION OF THE DRAWINGS

FIG. 1 is a schematic diagram of a circuit structure of a smart home system with a fast-charging function according to Embodiment 1 of the present disclosure;

FIG. 2 is a schematic diagram of a circuit structure of a smart home system with a fast-charging function according to Embodiment 2 of the present disclosure;

FIG. 3 is a schematic diagram of Wi-Fi connections of devices in a smart home system according to Embodiment 3 of the present disclosure;

FIG. 4 is a schematic diagram of Bluetooth connection between devices in a smart home system according to Embodiment 3 of the present disclosure;

FIG. 5 is a schematic diagram of Wi-Fi connections of devices in a smart home system according to Embodiment 4 of the present disclosure; and

FIG. 6 is a schematic diagram of Bluetooth connection between devices in a smart home system according to Embodiment 4 of the present disclosure.

Reference Numerals: 1—processor, 2—rectifier bridge, 3—AC-DC conversion circuit, 4—AC-DC conversion control circuit, 5—charging output detection circuit, 6—smart terminal device, 7—No. 1 smart lamp, 8—No. 2 smart lamp, 9—No. 3 smart lamp; 10—No. 4 smart lamp, 11—No. 5 smart lamp, and 12—Wi-Fi router.

### DETAILED DESCRIPTION

The technical solutions of the embodiments of the present disclosure are clearly and completely described below with reference to the accompanying drawings. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

In the description of the present disclosure, the terms such as “first”, “second”, and “third” are used only for the purpose of description and should not be construed as indicating or implying a relative importance, or implicitly indicating a quantity of indicated technical features. Thus, features defined with “first”, “second”, and “third” may explicitly or implicitly include one or more of the features. In the description of the present disclosure, unless otherwise specified, “a plurality of” means two or more.

In the description of the present disclosure, it should be noted that, unless otherwise clearly specified, meanings of terms “install”, “connected with”, and “connected to” should be understood in a broad sense. For example, the connection may be a fixed connection, a removable connection, or an integral connection; may be a mechanical connection or an electrical connection; may be a direct connection or an indirect connection by using an intermediate medium; or may be intercommunication between two components. A person of ordinary skill in the art may understand specific meanings of the foregoing terms in the present disclosure based on a specific situation.

In the description of the present disclosure, it should be noted that, unless otherwise defined, all technical and scientific terms used in the present disclosure have the same meaning as that commonly understood by a person skilled in the art of the present disclosure. The terms used in the specification of the present disclosure herein are only for the purpose of describing specific embodiments, and are not intended to limit the present disclosure. A person of ordinary skill in the art may understand specific meanings of the foregoing terms in the present disclosure based on a specific situation.

### Embodiment 1

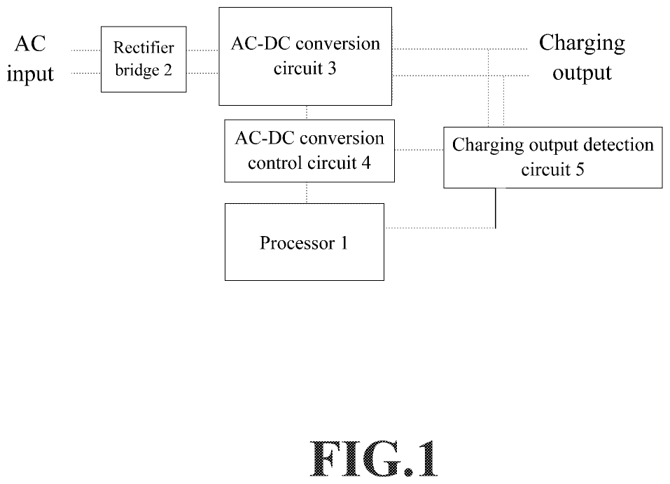

This embodiment provides a smart home system that integrates a wireless smart technology and a fast-charging technology. Specifically, FIG. 1 is a schematic diagram of a circuit structure of the smart home system with a fast-charging function according to this embodiment. A fast-charging control circuit, as an accessory of wireless smart products, includes a charging control module, and a charging conversion module and a charging detection module that are controlled by the charging control module. An input terminal of the charging conversion module is connected to an AC power supply, and an output terminal of the charging conversion module is connected to charging input terminals of the wireless smart products. The charging control module is configured to: receive and process detected data output by the charging detection module to obtain a data processing result, and send, to the charging conversion module, a regulation instruction corresponding to the data processing result, so as to regulate a real-time charging status of the fast-charging control circuit for the wireless smart products. It can be understood that, the smart home system may include a plurality of or various types of wireless smart products, which may be wireless smart lamps, wireless smart sockets, wireless smart switches, wireless smart sensors, or the like.

Preferably, the charging conversion module in this embodiment may include a rectifier bridge 2 and an AC-DC conversion circuit 3. An input terminal of the rectifier bridge may be connected to a power supply, and an output terminal of the rectifier bridge may be connected to an input terminal of the AC-DC conversion circuit. An output terminal of the AC-DC conversion circuit may be connected to the charging input terminals of the wireless smart products. The charging control module may include a processor and an AC-DC conversion control circuit, a control terminal of the AC-DC conversion circuit may be connected to the AC-DC conversion control circuit, and the AC-DC conversion control circuit may be connected to the processor. The charging detection module may be a charging output detection circuit, a detection terminal of the charging output detection circuit may be connected to the output terminal of the AC-DC conversion circuit, and an output terminal of the charging output detection circuit may be connected to the processor. The charging detection module may include a charging output detection circuit 5. The charging control module, the charging conversion module, and the charging detection module cooperate with each other to implement a fast-charging function of a product. In addition, a processor 1 in this embodiment may be configured to monitor charging of the wireless smart products. It can be understood that, the processor 1 may have a built-in control chip and its implementation circuit. Considering that currently, fast charging has gradually become a trend (for example, original ordinary chargers of mobile phones have gradually been replaced with fast chargers), the foregoing structure in this embodiment combines the wireless smart technology and the fast-charging technology together, which improves the charging rate of smart home products, and is conducive to monitoring the charging process of the products.

It should be noted that, for a structure of the fast-charging control circuit, reference may be made to the structure in the prior art, with another specific feature is added, to achieve a better fast-charging effect. The fast-charging control circuit in this embodiment is only an example, which can be improved by those skilled in the art on the premise of understanding. In addition, as the core of charging monitoring, the processor 1 may obtain the state parameters of the device from the charging output detection circuit. The parameters include but are not limited to a charging current, a charging voltage, and a battery charging state. The data of the state parameters received is processed and corresponding control instructions are sent to adjust the real-time charging status of each device. Preferably, the adjustment methods include but are not limited to: starting charging, stopping charging, adjusting a charging voltage, and adjusting a charging time, so that the charging endurance capacity of each smart device of the home system is effectively monitored, and the charging process of the device is ensured to be stable and effective. The automation of the home system is greatly improved and the actual user experience becomes better.

In addition, the fast-charging control circuit is an accessory for the wireless smart products, which means that the fast-charging control circuit is not an essential component of the smart home system, but a component that can be matched for use. Users can choose to equip some, all, or none of the wireless smart products with fast-charging control circuits depending on their specific needs, which improves the adaptability of the smart home system.

### Embodiment 2

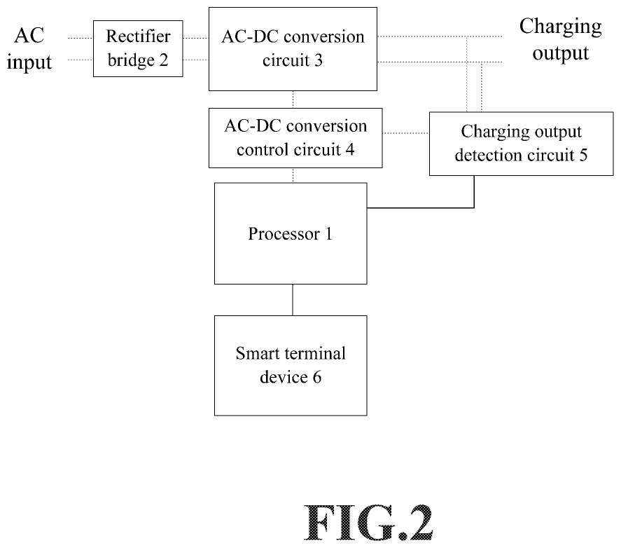

This embodiment provides a smart home system that integrates the wireless smart technology and the fast-charging technology. Specifically, FIG. 2 is a schematic diagram of a circuit structure of the smart home system with a fast-charging function according to this embodiment. Embodiment 2 is improved on the basis of Embodiment 1. In addition, a smart terminal device 6 is added, and communicates with the processor 1. The processor 1 can not only receive relevant parameters sent by the fast-charging control circuit, but also obtain commands sent by the smart terminal device 6, and correspondingly regulate charging status of each wireless smart product according to the received commands.

Preferably, the smart terminal device 6 may include a tablet, a mobile phone, a computer, and the like. The smart terminal device 6 sends the commands to the processor 1 of the smart home system through wireless transmission, so that the processor 1 sends corresponding control instructions. For example, the processor 1 sends a control instruction to a relevant chip in an AC-DC conversion control circuit 4 according to the received commands, to adjust a real-time charging status of the wireless smart device. In addition, there is preferably a two-way communication interaction between the processor 1 and the smart terminal device 6, and the processor 1 can report charging state parameters of the wireless smart device to the smart terminal device 6. Preferably, the smart terminal device 6 may be installed with a corresponding operational application (APP). The APP displays received parameter information, so that a user can remotely control a fast-charging device to work or stop working, and can remotely obtain an implementation status of the fast-charging device, which is convenient for the user to monitor the charging process in real time and implement higher-level settings of the APP, such as a scene, a timer and another function that requires the device to be online in a cloud.

The APP installed on the smart terminal device 6 may be operated to enable a Wi-Fi function on smart products that may be elected as a mesh gateway, including: 1) Bluetooth mesh smart products connected through the mesh gateway; and 2) Bluetooth mesh smart products disabled with the Wi-Fi function and connected through the mesh gateway. All these smart products can be displayed in a device list of the APP based on application of the products. It can be understood that, despite these products playing different roles in a communication process, users focus on only application functions of the products. According to this method, the users do not need to care about the wireless networking process of the products, functions such as mesh network establishment, device registration, and device control can be completed automatically.

It should be noted that communication interaction between the processor 1 and the smart terminal device 6 may involve a corresponding gateway and another protocol conversion device. Those skilled in the art should adjust the related structure of a charging circuit of the smart home system according to different devices and cost requirements.

In addition, the processor 1 may be primary or secondary in the circuit, and whether an isolation strategy or a non-isolation strategy of the circuit is used for connection depends on specific design requirements.

### Embodiment 3

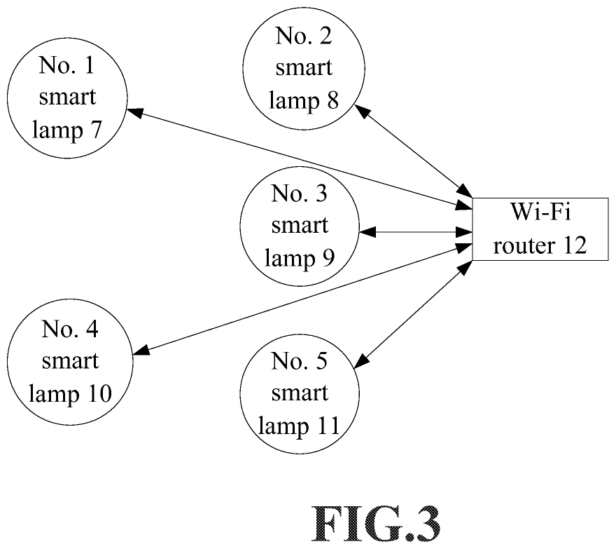

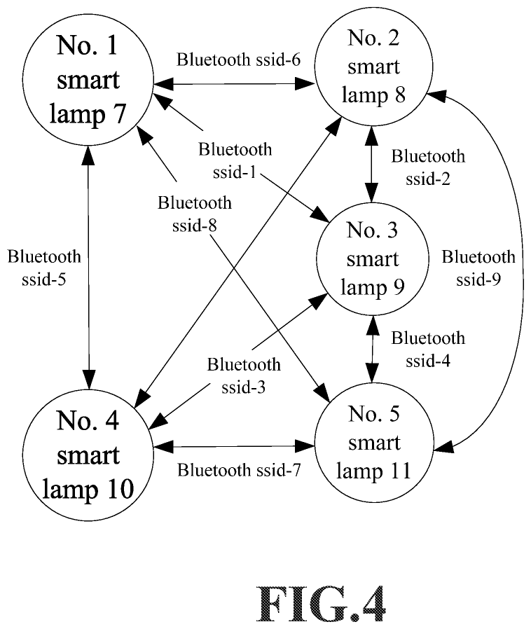

To improve the interconnection capability and network coordination capability of devices of a smart home system, this embodiment provides a network system framework of the smart home system. Specifically, referring to FIG. 3 and FIG. 4, FIG. 3 is a schematic diagram of Wi-Fi connections of devices in the smart home system according to this embodiment, and FIG. 4 is a schematic diagram of Bluetooth connection between devices in the smart home system according to this embodiment.

It should be noted that, with the popularization of Wi-Fi technologies and Bluetooth technologies, any device today can be connected to the network through Wi-Fi or Bluetooth to implement a remote cloud operation, with no exception for smart home devices. However, according to the inventor's research, for Wi-Fi, connection resources of a Wi-Fi router are required for network connection of each device, and when the quantity of Wi-Fi devices increases, an actual load of the Wi-Fi router is greatly increased, thereby affecting the performance of the router; and for Bluetooth, the advantage of the Bluetooth's mesh wireless technology lies in that devices can be directly connected through the mesh technology, but the disadvantage lies in that, in a wireless system, devices can be connected to the network only through a Bluetooth mesh to Wi-Fi gateway, to implement a remote cloud operation.

The interconnection between devices is limited by the quantity of activations. For example, there are 25 Wi-Fi lamps and 10 other Wi-Fi devices in a smart home system in a home, but the maximum quantity of devices that can be connected to a home Wi-Fi router is 32. In this case, there may be two problems that cause poor user experience: First, three of the devices cannot be connected to the Wi-Fi router normally; and second, different lamps in a lamp group are out of synchronization during control of the lamp group, and some lamps may have obvious delays.

In view of the above two shortcomings, this embodiment improves the interconnection capability and network coordination capability of devices by configuring a communication mode of the smart home devices. Preferably, the devices of the smart home system are preferably Bluetooth mesh devices with the Wi-Fi function. Such type of devices has both the capability of a mesh gateway and the capability of a mesh sub-device. A mesh gateway is elected from the devices in the system. An algorithm for electing the mesh gateway needs to take into account factors such as Wi-Fi rssi and mesh rssi. Herein, rssi denotes an indicator of received signal strength and is an optional part of a wireless transmission layer, which is used to determine the quality of connection, whether to increase the transmission strength, and the like.

The smart home system in this embodiment supports the function of hot switching between the mesh gateway and the mesh sub-device, and the Wi-Fi function of a device is enabled only when the device is elected as the gateway, so as to minimize the quantity of devices with the Wi-Fi function enabled. In addition, in the smart home system of this embodiment, a single node supports time-sharing distribution of network through mesh and Bluetooth low energy (BLE) (network distribution through Wi-Fi) and simultaneous distribution of network through BLE and Wi-Fi. By default, the network distribution through Wi-Fi is not recommended, so as to minimize the quantity of devices with the Wi-Fi function enabled.

In this embodiment, there are preferably a total of five Bluetooth mesh smart lamp devices with the Wi-Fi function (including No. 1 smart lamp 7, No. 2 smart lamp 8, No. 3 smart lamp 9, No. 4 smart lamp 10, and No. 5 smart lamp 11). Certainly, the quantity of devices depends on the actual situation. In addition to the smart lamps, the smart devices in the smart home system may be other related products with functions such as Wi-Fi, Bluetooth, or ZIGBEE. A specific election method in this embodiment is as follows: A mesh gateway is generated through election in the system. Based on an election algorithm, the No. 3 smart lamp 9 is elected as a small gateway of the network. After the election is completed, the No. 1, No. 2, No. 4, and No. 5 lamps automatically disable their Wi-Fi functions to reduce burden of the Wi-Fi router. A mesh network is established in the system through Bluetooth mesh, and users cannot feel noticeable delay when controlling a lamp group. The Bluetooth function allows the devices to be connected to each other, implementing a better interconnection capability. The following is one of the implementations of networking communication through Bluetooth. The No. 1 smart lamp 7 communicates with the No. 2 smart lamp 8 through a Bluetooth ssid-6 data link, communicates with the No. 3 smart lamp 9 through a Bluetooth ssid-1 data link, communicates with the No. 4 smart lamp 10 through a Bluetooth ssid-5 data link, and communicates with the No. 5 smart lamp 11 through a Bluetooth ssid-8 data link. The No. 2 smart lamp 8 communicates with the No. 3 smart lamp 9 through a Bluetooth ssid-2 data link, communicates with the No. 4 smart lamp 10 through a Bluetooth ssid-10 data link, and communicates with the No. 5 smart lamp 11 through a Bluetooth ssid-9 data link. The No. 3 smart lamp 9 communicates with the No. 4 smart lamp 10 through a Bluetooth ssid-3 data link, and communicates with the No. 5 smart lamp 11 through a Bluetooth ssid-4 data link. The No. 4 smart lamp 10 communicates with the No. 5 smart lamp 11 through a Bluetooth ssid-7 data link. It can be seen that, based on configuration of the communication mode of smart home devices, the interconnection capability and network coordination capability of the devices are improved, thereby improving the user experience.

In addition, because the smart devices in this embodiment are smart lamps, it is essential to involve battery-powered devices such as remote controllers or sensors. Based on the system framework of this embodiment, the battery-powered devices such as remote controllers or sensors can be well connected to a lighting system composed of the smart lamps without sacrificing the battery life. This resolves the problem of power consumption of the battery-powered devices such as remote controllers or sensors in the Wi-Fi wireless technology.

### Embodiment 4

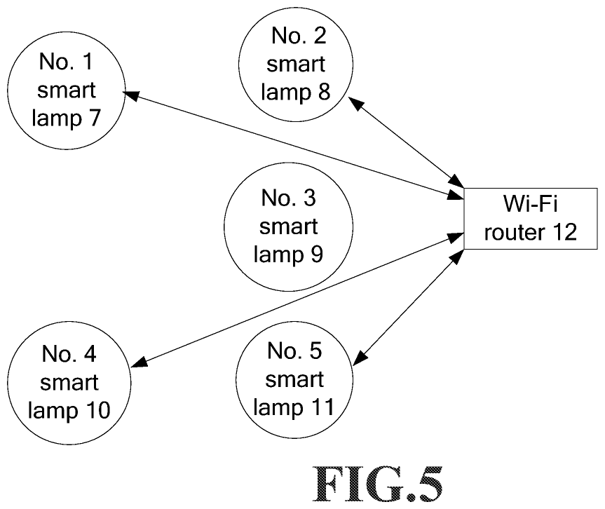

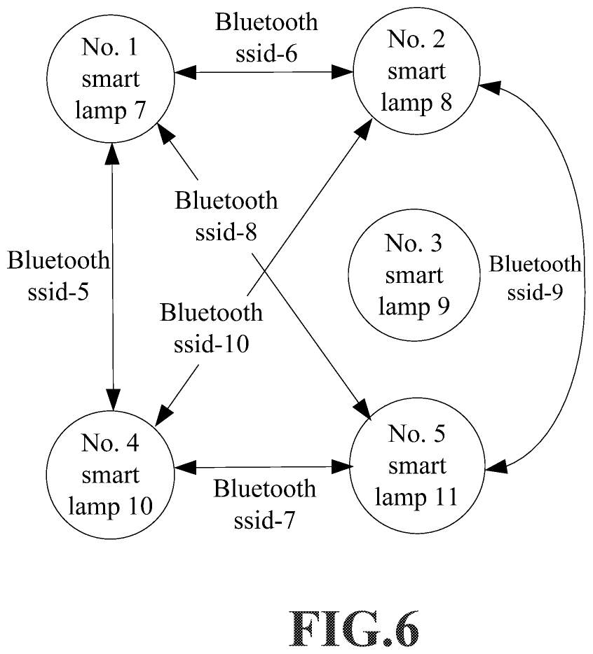

To improve the adaptability and optimization capability of devices of a smart home system, this embodiment provides a network system framework of the smart home system. Specifically, referring to FIG. 5 and FIG. 6, FIG. 5 is a schematic diagram of Wi-Fi connections of devices in the smart home system according to this embodiment, and FIG. 6 is a schematic diagram of Bluetooth connection between devices in the smart home system according to this embodiment.

In the smart home system in this embodiment, in a user account system, when one mesh gateway cannot be used to connect all devices, a plurality of mesh gateways are allowed to be generated, and devices in each mesh gateway can be interconnected to the Internet through a local area network (such as a home network). In addition, when the original gateway is powered off, an original mesh sub-device is automatically elected as the new gateway through a certain algorithm, to guarantee normal interconnection of the devices. The election implementation methods are as follows: 1) A wireless smart device with the Wi-Fi function and a Bluetooth mesh gateway in a home network is elected in a mesh network. 2) Wireless smart devices with the Wi-Fi function and Bluetooth mesh gateway are first used to establish a Bluetooth mesh network and then registered to a cloud one after another, and then the cloud elects a gateway according to strength of Wi-Fi connection signals or another parameter carried by the devices when they are used as primary devices and secondary devices. 3) Methods 1 and 2 are both used for election.

In this embodiment, there are preferably a total of five Bluetooth mesh smart lamp devices with the Wi-Fi function (the same as that in Embodiment 3). Certainly, the quantity of devices depends on the actual situation. In addition to the smart lamps, the smart devices in the smart home system may be other related products with functions such as Wi-Fi, Bluetooth, or ZIGBEE. A specific election method in this embodiment is as follows: A mesh gateway is generated through election in the system. Based on an election algorithm, the No. 3 smart lamp 9 is elected as a small gateway of the network. However, because the No. 3 smart lamp 9 is powered off for some reason, a new gateway needs to be elected from the remaining online lamps in the system. For example, the No. 1 smart lamp 7 is elected as the new small gateway of this network. After the election is completed, the No. 2, No. 4, and No. 5 lamps automatically disable their Wi-Fi functions to reduce burden of the Wi-Fi router. A mesh network is established in the system through Bluetooth, and users feel no noticeable delays when controlling a lamp group. The Bluetooth function allows the devices to be connected to each other, implementing a better interconnection capability. The following is one of the implementations of networking communication through Bluetooth. The No. 1 smart lamp 7 communicates with the No. 2 smart lamp 8 through a Bluetooth ssid-6 data link, communicates with the No. 4 smart lamp 10 through a Bluetooth ssid-5 data link, and communicates with the No. 5 smart lamp 11 through a Bluetooth ssid-8 data link. The No. 2 smart lamp 8 communicates with the No. 4 smart lamp 10 through a Bluetooth ssid-10 data link, and communicates with the No. 5 smart lamp 11 through a Bluetooth ssid-9 data link. The No. 4 smart lamp 10 communicates with the No. 5 smart lamp 11 through a Bluetooth ssid-7 data link. It can be seen that, based on configuration of a communication mode of smart home devices, the interconnection capability and network coordination capability of the devices are improved, thereby improving the user experience.

In addition, in this embodiment, a related external terminal device can also be disposed to communicate and interact with the smart home system, so that a user can remotely control the network connection to work or stop working, and can remotely obtain the real-time status of the network connection, which is convenient for the user to monitor the network function in real time.

The smart home system provided in the embodiments of the present disclosure has the following beneficial effects: The structure of the smart home system is optimized by improving the charging circuit, the network system framework, and the like of the smart home system, so that the charging rate of the smart home devices is greatly increased, the charging monitoring of the devices is more effective, and the network coordination capability between the devices is greatly improved. The interconnection between the devices is no longer limited by the quantity of activations, the entire smart home system has a high degree of automation, and the use performance is greatly improved, thereby lowering a use threshold for the user, simplifying an operation of the user, and accelerating an intelligentization process of the entire smart home system.

The descriptions above are preferred implementations of the present disclosure. It should be noted that for a person of ordinary skill in the art, various improvements and modifications can be made without departing from the principle of the present disclosure. These improvements and modifications should also be regarded as falling into the protection scope of the present disclosure.

1. A smart home system, comprising:
N wireless smart products and a fast-charging control circuit, wherein N≥3, and the fast-charging control circuit is an accessory for the wireless smart product, wherein the fast-charging control circuit comprises a charging control module, and a charging conversion module and a charging detection module that are controlled by the charging control module, an input terminal of the charging conversion module is connected to a power supply, and an output terminal of the charging conversion module is connected to charging input terminals of the wireless smart products; and the charging control module is at least configured to: receive and process detected data output by the charging detection module to obtain a data processing result, and send, to the charging conversion module, a regulation instruction corresponding to the data processing result, so as to regulate a real-time charging status of the fast-charging control circuit for the wireless smart product; and
each of the N wireless smart products is communicatively connected to a wireless fidelity (Wi-Fi) router, or
the N wireless smart products are communicatively connected to each other through Bluetooth signals, and each of M wireless smart products is equipped with a Bluetooth mesh gateway, wherein N≥M≥1, and R wireless smart products each equipped with the Bluetooth mesh gateway are communicatively connected to the Wi-Fi router, wherein M≥R≥1.

2. The smart home system according to claim 1, wherein the charging conversion module comprises a rectifier bridge and an AC-DC conversion circuit, an input terminal of the rectifier bridge is connected to the power supply, an output terminal of the rectifier bridge is connected to an input terminal of the AC-DC conversion circuit, and an output terminal of the AC-DC conversion circuit is connected to the charging input terminals of the wireless smart products;
the charging control module comprises a processor and an AC-DC conversion control circuit, a control terminal of the AC-DC conversion circuit is connected to the AC-DC conversion control circuit, and the AC-DC conversion control circuit is connected to the processor; and
the charging detection module is a charging output detection circuit, a detection terminal of the charging output detection circuit is connected to the output terminal of the AC-DC conversion circuit, and an output terminal of the charging output detection circuit is connected to the processor.

3. The smart home system according to claim 2, wherein the processor is configured to:
obtain, by using the charging output detection circuit, state parameters of the charging conversion module for supplying power to the wireless smart product, wherein the state parameters comprise a charging circuit, a charging voltage, and a battery charging state; and
process the state parameters to obtain a data processing result, and send, to the AC-DC conversion control circuit, a regulation instruction corresponding to the data processing result, so that the AC-DC conversion control circuit controls the AC-DC conversion circuit to achieve regulation of charging start and stop, a charging voltage, and a charging time.

4. The smart home system according to claim 2, wherein the smart home system further comprises a smart terminal device; and the processor is configured to:
receive a regulation instruction sent by the smart terminal device, and regulate a real-time charging status of the charging conversion module for the wireless smart product in response to the regulation instruction; and
obtain, by using the charging output detection circuit, state parameters of the charging conversion module for supplying power to the wireless smart product, and report the state parameters to the smart terminal device, wherein
the smart terminal device is communicatively connected to a wireless communication module in the processor through a protocol conversion device such as a gateway.

5. The smart home system according to claim 1, wherein when M=1, one of the N wireless smart products is equipped with the Bluetooth mesh gateway, and in this case, the N wireless smart products are communicatively connected to each other through Bluetooth signals, to form a wireless mesh network.

6. The smart home system according to claim 1, wherein when N≥M>1, at least one of the M wireless smart products each equipped with the Bluetooth mesh gateway is selected, based on an election algorithm, from the N wireless smart products to be enabled with a Wi-Fi function and communicatively connected to the Wi-Fi router; and the N wireless smart products are communicatively connected to each other through Bluetooth signals, to form a wireless mesh network.

7. The smart home system according to claim 1, wherein when N≥M>1, one of the M wireless smart products each equipped with the Bluetooth mesh gateway is selected, based on an election algorithm, from the N wireless smart products to be enabled with a Wi-Fi function and communicatively connected to the Wi-Fi router; and the N wireless smart products are communicatively connected to each other through Bluetooth signals, to form a wireless mesh network; and
when one wireless smart product, with the Wi-Fi function enabled, of the wireless smart products each equipped with the Bluetooth mesh gateway is powered off during work, another wireless smart product of M-1 wireless smart products each equipped with the Bluetooth mesh gateway is selected based on the election algorithm, to be enabled with the Wi-Fi function and communicatively connected to the Wi-Fi router.

8. The smart home system according to claim 1, wherein a manner of electing a mesh gateway from M wireless smart products each equipped with the Bluetooth mesh gateway is specifically:
establishing a wireless mesh network by using M wireless smart products each equipped with the Bluetooth mesh gateway in a local area network, selecting, based on an election algorithm, one of the wireless smart products in the wireless mesh network as the mesh gateway, to be enabled with a Wi-Fi function and communicatively connected to the Wi-Fi router; or
after establishing a wireless mesh network by using M wireless smart products each equipped with the Bluetooth mesh gateway, registering the M wireless smart products to a cloud via the Internet, and selecting, by the cloud, one of the M wireless smart products as the mesh gateway, to be enabled with the Wi-Fi function and communicatively connected to the Wi-Fi router; wherein
the smart home system further comprises a smart mobile terminal, and a software interface of the smart mobile terminal is provided with a function key of a gateway election manner for a user to select.

9. The smart home system according to claim 1, wherein the wireless smart product equipped with the Bluetooth mesh gateway is enabled with a Wi-Fi function to implement remote control, a cloud online function of a device, and a software function setting.

10. The smart home system according to claim 1, wherein the wireless smart product comprises a smart lamp.
